(19) United States
(12) Patent Application Publication
(10) Pub. No.: US 2022/0212592 A1
(43) Pub. Date: Jul. 7, 2022

(54) Mobile System For Supplying A Client With A Fluid

(71) Applicant: MESSER GASPACK GMBH, Krefeld (DE)

(72) Inventor: Alexander Kriese, Baden bei Wien (AT)

(73) Assignee: MESSER GASPACK GMBH, Krefeld (DE)

(21) Appl. No.: 17/438,151

(22) PCT Filed: Feb. 17, 2020
(86) PCT No.: PCT/EP2020/054011

§ 371 Date: Sep. 10, 2021

(30) Foreign Application Priority Data
Mar. 16, 2019 (DE) 10 2019 001 868.0

(51) Int. Cl. B60P 3/22; B60R 16/03

(52) U.S. Cl. CPC B60P 3/225; B60R 16/03

(57) ABSTRACT

Mobile supply systems are used to supply clients with a fluid, in which a transport container and a fluid pump for discharging the transport container into a client's container or a client's pipeline system are mounted on a tanker truck. The fluid pumps are usually fitted with hydraulic or electrical drive and are supplied with energy from the drive assembly of the tanker vehicle during the discharging process. In order to lower noise emissions at the target location caused by the discharging process, according to the invention, an electrical pump drive is used which is supplied with power at least optionally from an accumulator. The charging of the accumulator occurs by means of the drive assembly of the tanker vehicle, but independently of the discharging process, and can occur, in particular, during travel and/or outside of the target location.

### CROSS-REFERENCE TO RELATED APPLICATION

This application is the U.S. national stage of International Application No. PCT/EP2020/054011, filed Feb. 17, 2020, which International Application was published on Sep. 24, 2020, as International Publication No. WO 2020/187511 in the German language. The International Application claims priority to German Application No. 10 2019 001 868.0, filed Mar. 16, 2019. The International Application and German Application are incorporated herein by reference, in their entireties.

### FIELD

The invention relates to a mobile system for supplying a customer with a fluid, having a tanker vehicle, which is equipped with a vehicle drive unit and on which a transport container for storing a fluid and a fluid pump, driven by means of an electric pump drive, for discharging the transported fluid from the transport container are arranged.

### BACKGROUND

To supply customers with fluids, for example liquids, bulk materials, pasty compounds or gases in liquid or gas form, tanker lorries, in particular road tankers, are used. The tanker lorries have a transport container which is suitable for the fluid to be transported in each case and is equipped with a filling line for connection to a container provided by the customer for filling or to a customer network. Since, in many cases, equipment for unloading the transport container is not available at the destination, the tanker lorries themselves usually have to be equipped with fluid pumps or delivery units installed in a fixed manner on the vehicle. To actuate these fluid pumps or delivery units, three technical drive types are currently predominantly used:
a) the pump drive is implemented hydraulically by means of a hydraulic pump installed on board,
b) the pump drive is implemented electrically by means of a generator installed on board,
c) the pump drive is implemented electrically and powered by the mains supply present at the destination.

In the case of drive types a) and b), the required power is generated by the drive unit of the vehicle, generally a diesel engine, which means, however, that the unit has to be operated significantly above idling speed during the unloading procedure, which results in undesired noise emissions. In many cases, the unloading of the vehicle can therefore only take place within a restricted time window, which means that the carrier has to accept restrictions in its logistics. Therefore, for example, discharging liquid oxygen from a tanker vehicle into the customer tank of a hospital during the night is often prohibited for reasons of noise control.

Although the drive type c) solves this problem, the discharge of fluids often demands a high electrical power of 20 kW and more, for example, such that the provision thereof at the destination may only be possible with considerable difficulty, if at all. So as to not be dependent on such situations, the option a) is used in most cases today, i.e. the tanker vehicle has a hydraulic pump drive such as that described in U.S. Pat. No. 4,416,590 B or US 2006 0156742 A1, for example.

### SUMMARY

The invention is therefore based on the object of creating an alternative option for the discharge of fluids which overcomes the disadvantages of the prior art.

This object is achieved by a mobile system having the features of claim 1. Advantageous configurations of the invention are indicated in the subclaims.

A mobile system for supplying a customer with a fluid of the type and for the purpose mentioned at the outset is characterized according to the invention in that the tanker vehicle has a generator, which is driven by the vehicle drive unit, and an accumulator, which can be electrically connected to said generator, and the accumulator can be electrically connected to the pump drive in order to supply power thereto.

The transport container is therefore equipped with an extraction connection for temporary connection to a line, a container or a fluid network of a customer. The emptying of the transport container takes place by means of the fluid pump installed on the tanker vehicle, which in turn possesses an electric pump drive. According to the invention, in contrast to the systems known from the prior art, an accumulator, i.e. a rechargeable electric battery, is provided in order to supply power to the pump drive on board the tanker vehicle, which battery serves to supply power to the pump drive during the discharging procedure and is charged via the generator. The accumulator preferably has sufficient power and contains sufficient energy to be able to realize complete emptying of the transport container by means of the fluid pump, even if it was previously filled completely. In the case of tanker vehicles which are conventionally used to successively supply multiple customers with partial amounts of the fluid load from the transport container, it is also conceivable to design the capacity of the accumulator to be smaller, namely such that it is at least sufficient to be able to supply the next customer in each case with fluid. In this case, it must, however, be ensured that the accumulator can be charged again by the generator on the journey to the next customer.

The generator which can be electrically connected to the accumulator is, in particular, the electric generator of the vehicle drive unit. The charging of the accumulator can therefore take place via the vehicle's own drive unit whilst the tanker vehicle is being driven in that the accumulator is connected to the electric generator. In particular, on return journeys following discharging procedures in which the transport container has been at least partially emptied and therefore less power is required for the vehicle drive, sufficient power is available for charging the accumulator without a more powerful drive unit and/or an additional generator necessarily having to be present on the tanker vehicle. However, within the context of the invention, it is not impossible that the tanker vehicle is equipped with a more powerful, additional and/or adapted electric generator for this purpose.

The inventive system possesses the same flexibility as systems according to the prior art which operate with hydraulic pumps or with generators driven by the vehicle drive unit, which are installed on the tanker vehicle. However, it is linked to significantly lower noise emissions during operation. Although the inventive system also causes noise emissions during the discharging procedure owing to the running pump, its sound pressure is significantly lower than that of a conventional diesel lorry engine in partial load operation.

Accordingly, the time window in which a discharging procedure can take place can be increased significantly in many cases, whereby the logistics can be improved.

A further configuration of the invention is characterized in that in that the accumulator and/or the pump drive is equipped with connections for the connection of an external power supply network. In this case, the accumulator can alternatively be charged from the external mains supply or, if a sufficiently powerful external power supply is present, the pump can also be operated directly using external power.

In another advantageous embodiment of the invention, the generator can be electrically connected directly to the pump drive in order to supply power thereto. In this configuration, in cases in which the noise emission is not critical, the power supply to the fluid pump can therefore be realized directly via the generator whilst bypassing the accumulator. In this case, the tanker vehicle is preferably equipped with a switching device which enables the power supply to the pump drive to be switched between accumulator operation, generator operation and/or operation by means of an external power supply.

The mobile system preferably serves for transporting cryogenic gases, in particular cryogenic liquefied gases such as liquid oxygen, liquid nitrogen or liquid carbon dioxide. The tank therefore has thermal insulation and the fluid pump is suitable for delivering cryogenic gases.

In an again advantageous configuration of the invention, the tanker vehicle is equipped with a control unit which enables the charging of the accumulator according to a specified program or depending on specified parameters. This configuration serves in particular for automatically identifying the opportunity to decouple power from the vehicle drive unit in order to charge the accumulator, for example whilst the tanker vehicle is being driven. The control unit can moreover also be used to prevent exhaust gas emissions during the discharging procedure, i.e. during a discharging procedure in the vicinity of a hospital, and to relocate them to an area which is less critical in terms of emissions, for example a trunk road along which the tanker vehicle will be driven. This can be ensured in particular by a program installed in the control unit.

The tanker vehicle is preferably an articulated lorry, which consists of a tractor unit equipped with the drive unit and a trailer on which the transport container and the fluid pump with the pump drive and the accumulator are mounted. During operation of the tanker vehicle, the accumulator is connected to the electric generator of the drive unit of the tractor unit via an electric line equipped with a switch, wherein the switch can preferably be actuated via an automatic control or manually by the driver of the tractor unit. In the case of a low charge status of the accumulator, recharging of the accumulator can therefore take place via the electric generator of the tractor unit whilst the articulated lorry is being driven and the accumulator can be electrically disconnected from the electric generator after the charging of the accumulator has taken place. Moreover, the tractor unit preferably does not have any special technical features compared to a conventional tractor unit of an articulated lorry and can therefore be easily replaced by another tractor unit in the event of maintenance or repair work on the tractor unit. Within the context of this invention, however, it is also not impossible that the described device is installed on a mono vehicle, i.e. a vehicle in which the transport container, the fluid pump with the pump drive and the accumulator and the drive unit with the electric generator of the tanker vehicle are arranged on a common chassis.

### BRIEF DESCRIPTION OF THE DRAWING

An exemplary embodiment of the invention shall be explained in more detail with reference to the drawing.

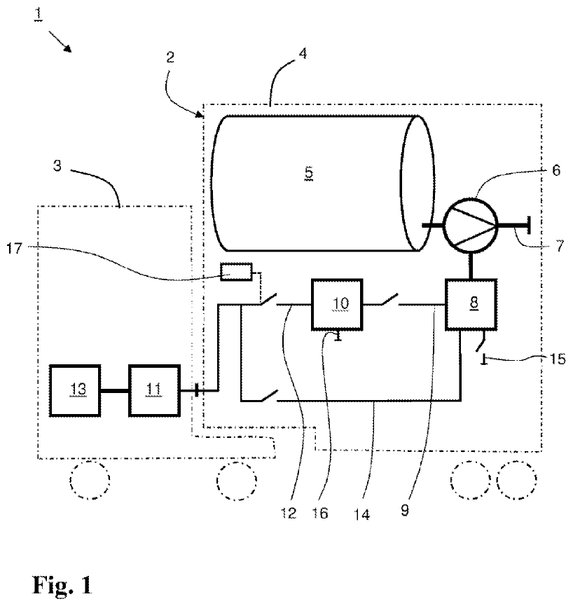

The single drawing (FIG. 1) shows a schematic representation of a circuit diagram of a mobile system for supplying a customer with a fluid according to the invention.

### DETAILED DESCRIPTION

The mobile system 1 comprises a tanker vehicle 2, which, in the exemplary embodiment, is an articulated tanker lorry consisting of a tractor unit 3 and a tanker trailer 4.

A transport container 5 for storing a fluid, for example a tank for storing a cryogenic liquefied gas, is mounted on the tanker trailer 4. A fluid pump 6, which is installed in an outlet line 7 of the transport container 5, serves to discharge fluid from the transport container 5.

The fluid pump 6 is designed as an electric pump and is driven by an electric pump drive 8. According to the invention, to supply power to the pump drive 8, this latter is electrically connected to an accumulator 10 via a line 9.

The accumulator 10 is electrically charged via a generator 11 to which it can be electrically connected via a line 12. The generator 11 arranged in the tractor unit 3 in the exemplary embodiment shown here is driven by an engine 13, which is, in particular, the drive unit of the tractor unit 3. The generator 11 is, for example, the electric generator present as standard in the tractor unit 3; however, it can also be an electric generator with increased power compared to a pre-installed electric generator or a generator which is present in addition to the electric generator and is driven by the engine 13.

The accumulator 10 is preferably configured such that the power which can be drawn from it and the energy which it contains is sufficient to enable complete emptying of the transport container 5 into a customer tank or into a supply network of a customer even if the transport container 5 was previously filled completely. If a tanker vehicle 2 normally has to be driven to multiple customers in succession, it is, however, also conceivable to configure the capacity of the accumulator 10 to be somewhat smaller provided it is ensured that at least partial recharging of the accumulator 10 takes place during the journey to the next customer and is sufficient to be able to cover the supply of fluid to the next customer in each case.

During operation of the mobile system 1, a customer tank to be filled or a customer network (neither shown here) is connected to the discharge line 7 and fluid is emptied from the supply container 5 into the customer tank or the customer network by means of the fluid pump 6. The pump drive 8 draws the electrical energy required to operate the fluid pump 6 from the accumulator 10. During the discharging procedure, the operation of a generator ensuring the power supply to the fluid pump 6 is therefore not required, which is why the device 1 has significantly lower noise emissions compared to discharge devices according to the prior art.

Recharging of the accumulator 10 is required after the completion of a discharging procedure or a series of successively implemented discharging procedures. To this end, the accumulator 10 is electrically connected to the generator 11, which provides the required charging current through the operation of the engine 13. In this case, the charging of the accumulator 10 can take place independently of the discharging procedure; in particular, it takes place during the return journey of the tanker vehicle 2 from a customer in the empty state of the supply container 5.

In the exemplary embodiment shown here, instead of supplying power to the pump drive 8 via the accumulator, this can also take place directly by means of the generator 11 via an electric line 14 which bypasses the accumulator 10; this mode of operation is recommended with regard to noise emissions in a non-critical environment since the losses in the accumulator are thus prevented.

In the exemplary embodiment shown here, as a further alternative for supplying power to the pump drive 8, this latter has a connection 15 for connection to an external power network (not shown here), for example the power network of a customer. The accumulator 10 likewise expediently possesses a charging connection 16, which also enables the charging of the accumulator 10 by means of an external power network when the engine 13 is switched off.

Moreover, the charging of the accumulator 10 can be regulated by means of an electronic control unit 17 according to a specified program or according to detected parameters, for example the charge status of the accumulator or the operating status of the tanker vehicle 2.

In particular, the control unit enables automatic charging of the accumulator 10 whilst the tanker vehicle 2 is being driven.

### LIST OF REFERENCE SIGNS

1 System
2 Tanker lorry
3 Tractor unit
4 Trailer
5 Transport container
6 Fluid pump
7 Outlet line
8 Pump drive
9 Electric line
10 Accumulator
11 Generator
12 Electric line
13 Engine
14 Electric line
15 Electrical connection
16 Charging connection
17 Control unit

1. A mobile system for supplying a customer with a fluid, having a tanker vehicle, which is equipped with a vehicle drive unit and on which a transport container for storing a fluid and a fluid pump, driven by means of an electric pump drive, for discharging the transported fluid from the transport container are arranged,
wherein the tanker vehicle has a generator, which is driven by the vehicle drive unit, and an accumulator, which can be electrically connected to said generator, and the accumulator can be electrically connected to the pump drive in order to supply power thereto.

2. The mobile system as claimed in claim 1, wherein the accumulator and/or the pump drive is equipped with connections for connection to an external power supply network.

3. The mobile system as claimed in claim 1, wherein the generator can be electrically connected directly to the pump drive in order to supply power directly thereto.

4. The mobile system as claimed in claim 1, wherein a tank for storing liquefied gases is provided as the transport container.

5. The mobile system as claimed claim 1, wherein the tanker vehicle is equipped with a control unit which enables the charging of the accumulator according to a specified program or depending on specified parameters.

6. The mobile system as claimed in claim 1, wherein the tanker vehicle is designed as an articulated lorry having a tractor unit and a trailer, the transport container, the pump with the pump drive and the accumulator being mounted on the trailer.
